(19) United States
(12) Patent Application Publication
(10) Pub. No.: US 2016/0077762 A1
(43) Pub. Date: Mar. 17, 2016

(54) MEMORY SYSTEM, STORAGE SYSTEM

(71) Applicant: Kabushiki Kaisha Toshiba, Tokyo (JP)

(72) Inventors: Takashi Ide, Yokohama Kanagawa (JP); Kouji Watanabe, Tokyo (JP)

(21) Appl. No.: 14/554,925

(22) Filed: Nov. 26, 2014

Related U.S. Application Data
(60) Provisional application No. 62/048,964, filed on Sep. 11, 2014.

(51) Int. Cl. G06F 3/06

(52) U.S. Cl. CPC G06F 3/0635; G06F 3/061; G06F 3/0688

(57) ABSTRACT

According to one embodiment, a memory system includes a plurality of nonvolatile memories, a generator which generates a select information, an issuing unit which issues a select command including the select information, a decoder which decodes the select information and the select command, and a selector which selects one of the plurality of nonvolatile memories on the basis of the decoding result from the decoder.

### CROSS-REFERENCE TO RELATED APPLICATIONS

This application claims the benefit of U.S. Provisional Application No. 62/048,964, filed Sep. 11, 2014, the entire contents of which are incorporated herein by reference.

### FIELD

Embodiments described herein relate generally to a memory system and a storage system.

### BACKGROUND

There has been a solid-state drive (SSD) with the same interface as a hard disc drive (HDD), including a plurality of nonvolatile semiconductor memories as storage media.

### BRIEF DESCRIPTION OF THE DRAWINGS

FIG. 1 is a perspective illustration of a storage system using a memory system according to the first embodiment;

FIG. 2 is a block diagram showing a circuit configuration of a memory system according to the first embodiment;

FIG. 3 is a flow chart of a NAND chip select operation according to the first embodiment;

FIG. 4A is a timing chart of a command sequence between an SSD controller and a switching unit following FIG. 3;

FIG. 4B is a timing chart of a command sequence between the switching unit, NAND chip0 and NAND chip1 following FIG. 3;

FIG. 5 is a block diagram showing a circuit configuration of a memory system according to the second embodiment;

FIG. 6 is a flow chart of a NAND chip select operation according to the second embodiment;

FIG. 7A is a timing chart of a command sequence between an SSD controller and a switching unit following FIG. 6;

FIG. 7B is a timing chart of a command sequence between the switching unit, NAND chip0 and NAND chip1 following FIG. 6;

FIG. 8 is a block diagram showing a circuit configuration of a memory system according to the third embodiment;

FIG. 9 is a flow chart of a NAND chip select operation according to the third embodiment;

FIG. 10A is a timing chart of a command sequence between an SSD controller and a switching unit following FIG. 9;

FIG. 10B is a timing chart of a command sequence between the switching unit, NAND chip0 and NAND chip1 following FIG. 9; and

FIG. 11 is a timing chart of a command sequence according to Variation 1.

### DETAILED DESCRIPTION

Various embodiments will be described hereinafter with reference to the accompanying drawings.

In general, according to one embodiment, a memory system includes a plurality of nonvolatile memories, a generator which generates a select information, an issuing unit which issues a select command including the select information, a decoder which decodes the select information and the select command, and a selector which selects one of the plurality of nonvolatile memories on the basis of the decoding result from the decoder.

In this specification, more than two terms are given to some of the components. These terms are merely examples, and those components may be expressed with other terms. Furthermore, components which are given only one term may be expressed with other terms.

Also, the appended drawings are schematic ones, in which the relationship between the thickness and the planar dimension, and/or the ratio in thickness between each layers may differ from the reality. Further, the relationship and/or the ratio in dimension may vary between the drawings.

### First Embodiment

### 1. Structure

[1-1. Storage System]

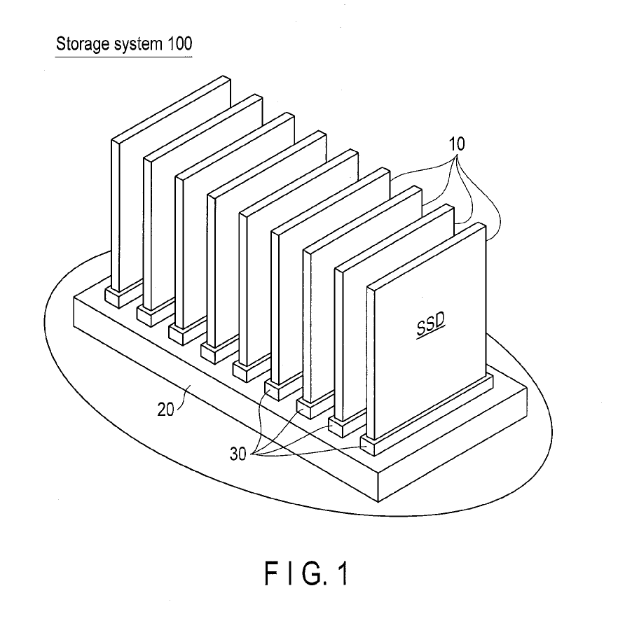

First, referring to FIG. 1, a storage system 100 incorporating a memory system 10 according to the first embodiment is described. In this embodiment, the storage system 100 uses a plurality of solid-state drives (SSDs) as an example of the memory system 10. The SSD 10 according to this embodiment is, for example, a relatively small module, and its outer size in one instance is approximately 20 mm×30 mm. Note that the size of the SSDs 10 is not limited to the above, and may be changed in a wide range.

As shown, each SSD 10 according to the first embodiment can be used being mounted to a server-like host device 20 in, for example, a data center or a cloud computing system operated in a company (enterprise). Thus, each SSD 10 according to this embodiment may be an enterprise SSD (eSSD) used in a server (or a PC), for example.

The host device 20 comprises a plurality of connectors (for example, slots) 30 which are opened upward, for example. Each connector 30 is, for example, a Serial Attached SCSI (SAS) connector. The SAS connector enables the host device 20 and each SSD 10 to perform high-speed communication with each other utilizing a 6-Gbps dual port. Meanwhile, each connector 30 is not limited to the above, and may be, for example, PCI express (PCIe) or NVM express (NVMe).

Further, the SSDs 10 are mounted to the connectors 30 of the host device 20, respectively, to be supported side by side with each other in standing posture in substantially vertical direction. This structure enables a plurality of memory systems 10 to be compactly mounted together, and to downsize the host device 20. Furthermore, each SSD 10 according to this embodiment is a 2.5 inch SFF (small form factor). Such a shape allows the SSD 10 to be compatible with an enterprise HDD (eHDD) in shape and realizes an easy system compatibility with an enterprise HDD. Note that, the SSDs 10 are not limited to enterprise ones. For example, the SSD 10 is of course applicable as a storage medium of a consumer electronic device such as a notebook portable computer and a tablet device.

[1-2. Memory System]

[1-2-1. Circuit Configuration]

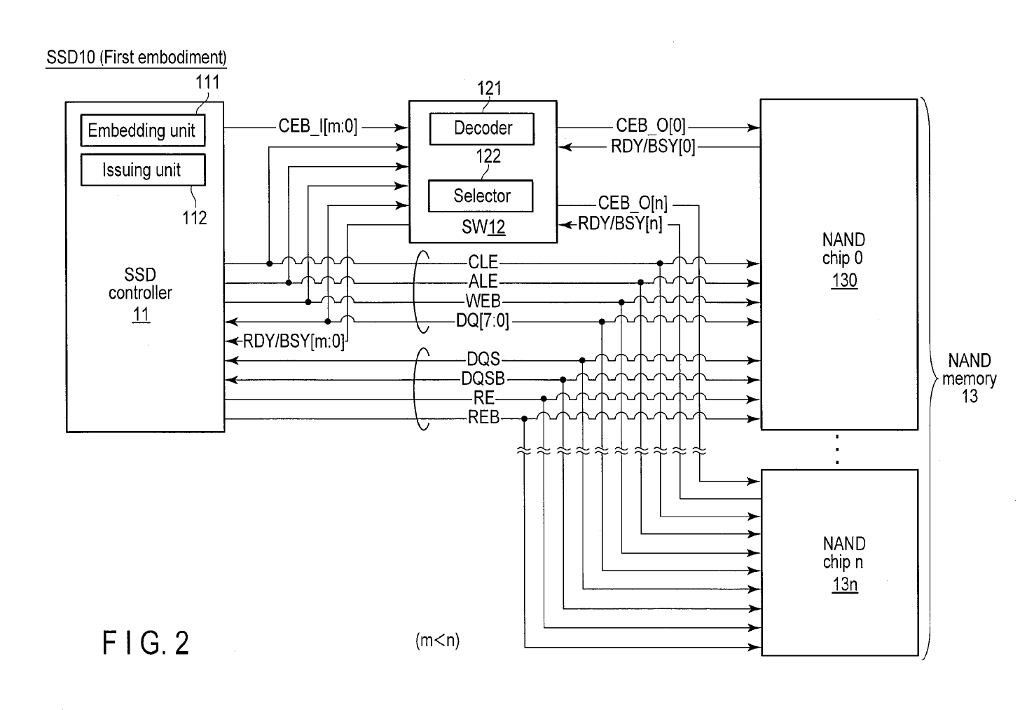

Secondly, referring to FIG. 2, a circuit configuration of memory system (SSD) 10 according to the first embodiment is described. Signals exchanged between each circuit configuring the memory system 10 will hereinafter be described in detail.

As shown, the memory system (SSD) 10 according to the first embodiment includes an SSD controller 11, a switching unit 12, and a NAND flash memory 13.

The SSD controller (memory controller, controller) 11 controls the entire operation of the memory system 10 according to a request from the host device 20. The SSD controller 11 according to the first embodiment includes an embedding unit 111 and an issuing unit 112.

The embedding unit (generating unit, generator) 111 generates a NAND chip select information IS to select an after-mentioned NAND chip. Then, the embedding unit 111 embeds the generated NAND chip select information IS into a remaining bit (redundant bit information) such as a predetermined select command or an address.

The issuing unit 112 issues a unique definitional predetermined select command (or an address) including the NAND chip select information IS embedded by the embedding unit 111 and complying with the NAND interface protocol. The issued command or address is transmitted to the switching unit 12 and the NAND flash memory 13 by data DQ [7:0].

The switching unit (SW, signal switching unit, switch) 12 selects an intended, access targeted NAND chip, according to the NAND chip select information IS transmitted from the SSD controller 11. In order to execute this selection, the switching unit 12 includes a decoder 121 and a selector 122.

The decoding unit (decoder) 121 decodes the NAND chip select information IS embedded in a command (or an address).

The selecting unit (selector) 122 selects an intended, access targeted NAND chip according to the decoding result of the NAND chip select information IS from the decoder 121.

The NAND flash memory (hereinafter referred to as NAND memory) 13 is a nonvolatile memory consisting of a plurality (n, a natural number of 2 or greater) of NAND chips 130-13n.

Each NAND chip 130-13n consists of a plurality of physical blocks including a plurality of memory cells placed in each intersection point of ward lines and bit lines. In an NAND memory 13, data is erased by the physical block in a job lot. In other words, a physical block is equal to a data erasure unit. Note that writing and reading is performed by page (word line) in each blocks. Further, each NAND chip 130-13n may mount a plurality of NAND chips.

[1-2-2. Signals]

Next, referring to FIG. 2, signals communicated between each circuits consisting SSD 10 is described. Note that “B” in the below-mentioned signal represents a complementary signal, and “S” represents a strobe signal (a timing signal for reading). Further, “_I” indicates that the signal is an input signal, and “_O” indicates that the signal is an output signal from the view point of the switching unit 12.

[CEB, RDY/BSY]

Chip enable signal (selection signal) CEB_I [m:0] (in this regard, m is a natural number less than n (m<n)) is transmitted from the SSD controller 11 to the switching unit 12. The switching unit 12 transmits ready/busy signal RDY/BSY [m:0] indicating its ready state/busy state to the SSD controller 11, on the basis of its operating state.

Further, switching unit 12 transmits valid/invalid of the chip enable signal CEB_O [0] to [n] to each NAND chip 130-13n on the basis of the chip enable signal CEB_I [m:0] and the decode result from decoding unit 122, and selects one of NAND chips 130-13n. Each NAND chip 130-13n transmits ready/busy signal RDY/BSY [0] to [n] indicating its ready state/busy state to the switching unit 12, on the basis of its operating state.

[CLE, ALE, WEB, DQ]

Command latch enable signal CLE, address latch enable signal ALE, write enable signal WEB, and data DQ [7:0] are transmitted to both the switching unit 12 and the NAND memory 13 from the SSD controller 11.

Note that the data DQ [7:0] is an 8 bit signal line, through which not only write and read data, but also controlling signal such as commands (cmd) and addresses (Adr) are transmitted and received.

[DQS, DQSB, RE, REB]

Data DQS, DQSB, and read enable signal RE, REB are directly transmitted from the SSD controller 11 to the NAND memory 13, without involving the switching unit 12.

### 2. NAND Chip Select Operation

[2-1. NAND Chip Select Flow]

Next, in the configuration set forth above, NAND chip select operation of the memory system 10 according to the first embodiment is described.

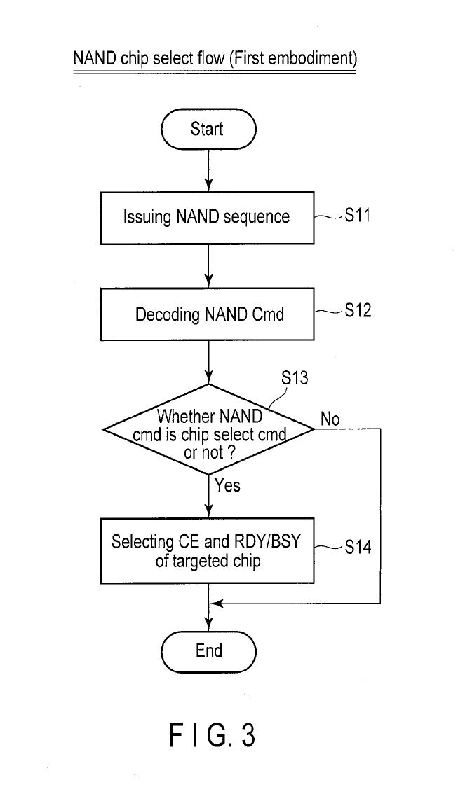

As shown in FIG. 3, the memory system 10 according to the first embodiment selects one of the access targeted NAND chips 130-13n. In this instance, it selects and accesses NAND chip 130 in the write operation.

First, in step S11, the SSD controller 11 issues a predetermined sequence including a unique definitional predetermined select command complying with the NAND interface (NAND I/F) protocol.

To be more precise, at first, the embedding unit 111 of the SSD controller 11 embeds a NAND chip select information IS for selecting NAND chip 130 into a remaining bit (redundant bit information) of the select command (Cmd CC0). Subsequently, the issuing unit 112 of the SSD controller 11 issues a unique definitional select command including the NAND chip select information IS and complying with the NAND interface protocol.

In addition, the SSD controller 11 serially issues a predetermined write command (Cmd 80), an address (Adr), write data (WriteData), and a write-start command (Cmd 10).

In step S12, the decoding unit 121 of the switching unit 12 decodes the NAND chip select information IS embedded in the issued command (Cmd CC0).

In step S13, a determination unit (not shown in the figure) in the switching unit 12 determines whether the decoded command is the predetermined select command (Cmd CC0) to select the NAND chip or not. If the command is not the predetermined select command (Cmd CC0) (“No” in S13), the operation is ended.

In step S14, if the decoded command is the predetermined select command (Cmd CC0) (“Yes” in S13), the selecting unit 122 of the switching unit 12 selects a chip enable signal CEB_I and a ready/busy signal RDY/BSY_I of the access targeted NAND chip. Specifically, in this instance, the selecting unit 122 makes the chip enable signal CEB_I [0] of NAND chip 130 valid and selects NAND chip 130. In addition, the selecting unit 122 transmits a ready state signal of ready/busy signal RDY/BSY_I [0] as a response signal to the SSD controller 11 according to the selected chip enable signal, and ends the operation.

The same applies hereafter, the memory system 10 according to the first embodiment repeats the above NAND chip select operation.

[2-2. NAND Chip Select Timing Chart]

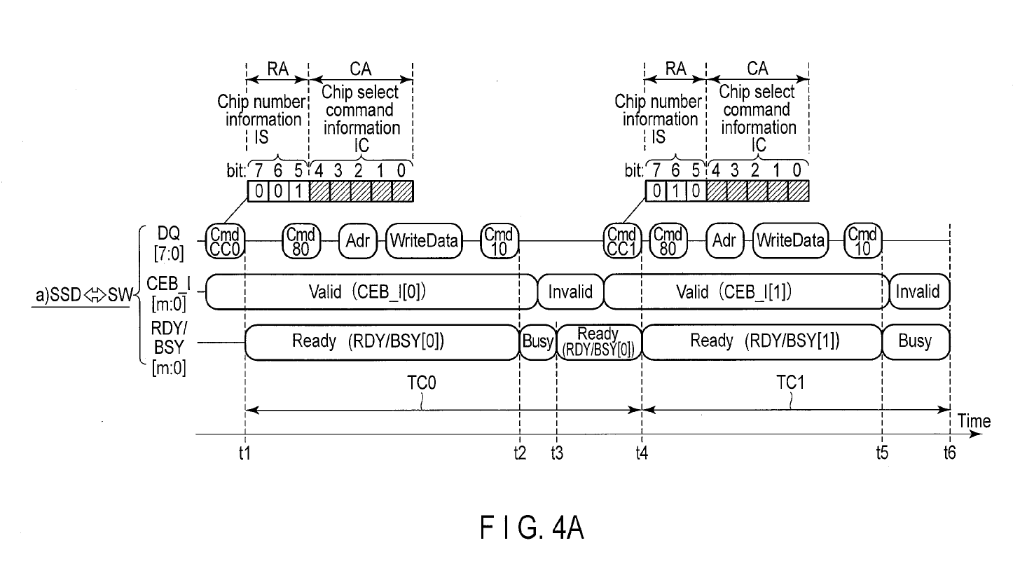

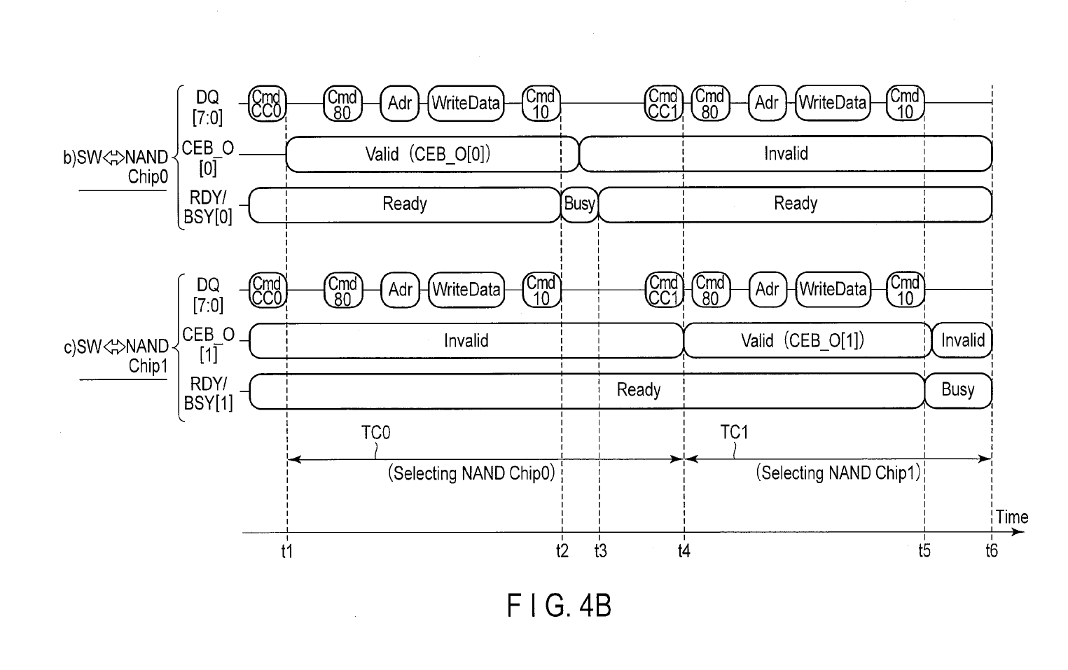

According to the NAND chip select flow according to the first embodiment, for example, the NAND chip select timing chart is as shown in FIG. 4A and FIG. 4B. In this instance, NAND chips 130 and 131 are accessed serially.

First, at time t1, as indicated as a) in FIG. 4A, the decoding unit 121 decodes the select command for selecting NAND chip 130 and the NAND chip select information IS embedded in the command.

The select command (Cmd CC0) issued by the issuing unit 112 complies the NAND interface (NAND I/F) protocol as noted above, and is a unique definitional predetermined command. Therefore, the select command (Cmd CC0) is transmitted to the switching unit 12 and the NAND memory 13 by the data DQ_I [7:0], but is not recognized by the NAND memory 13, and is recognized by the decoding unit 121 of the switching unit 12.

Further, in a remaining bit area (redundant bit area) RA, which is a remaining bits (bits 5-7) of the select command (Cmd CC0), is embedded a chip number information as a NAND chip select information IS. In this instance, as select information IS corresponding to NAND chip 130, chip number information ‘001’ is embedded.

On the other hand, in a command bit area CA which is of the other bits (bits 0-4), a chip select command information IC for recognizing the select command (Cmd CC0) is embedded.

The configuration of a select command (Cmd CC0), such as the one described above, enables the decoding unit 121 decode this command utilizing the select command information IC. Also, the decoding unit 121 decodes the select information IS.

On the basis of the decode result, the selecting unit 122 of the switching unit 12 makes the chip enable signal CEB_I [0] of the access targeted NAND chip 130 valid. Furthermore, the selecting unit 122 transmits a ready state of ready/busy signal RDY/BSY_I [0] as a response signal to the SSD controller 11 according to the selected chip enable signal CEB_I [0].

In addition, as indicated as b) and c) in FIG. 4B, the switching unit 12 makes the chip enable signal CEB_O [0] of NAND chip 130 valid and selects NAND chip 130, on the basis of the chip enable signal CEB_I [0] and the decode result. On the other hand, the switching unit 12 makes the chip enable signal CEB_O [1]-[n] of the other NAND chips 131-13n invalid and does not select those NAND chips 131-13n.

Then, each NAND chip 130-13n transmits a ready state or a busy state signal of ready/busy signal RDY/BSY [0]-[n] to the switching unit 12, on the basis of its operating state.

Subsequently, the SSD controller 11 serially issues a predetermined write command (Cmd 80), an address (Adr), write data (WriteData), and write-start command (Cmd 10).

At time t2, as soon as NAND chip 130 starts writing, NAND chip 130 transmits a busy state of ready/busy signal RDY/BSY_O [0] to the switching unit 12.

At time t3, the switching unit 12 outputs a ready state signal of ready/busy signal RDY/BSY_O [0] to the SSD controller 11. The ready/busy signal RDY/BSY [m:0] is an output signal from the switching unit 12. Therefore, until the chip selection of the selected NAND chip 130 is over, the switching unit 12 keeps outputting a ready/busy signal RDY/BSY [0] of the selected NAND chip 130 to the SSD controller 11.

At time t4, as indicated as a) in FIG. 4A, the decoding unit 121 decodes the select command (Cmd CC1) for selecting NAND chip 131 and the NAND chip select information IS embedded in the command.

As described above, the select command (Cmd CC1) issued by the issuing unit 112 complies the NAND interface (NAND I/F) protocol, and is a unique definitional predetermined command. Further, in the remaining bit area (redundant bit area) RA, which is a remaining bits (bits 5-7) of the select command (Cmd CC1), is embedded a chip number information as a NAND chip select information IS. In this instance, as select information IS corresponding to NAND chip 131, chip number information ‘010’ is embedded.

On the other hand, in the command bit area CA which is of the other bits (bits 0-4), a chip select command information IC for recognizing the select command (Cmd CC1) is embedded.

With the configuration of such a select command (Cmd CC1) as described above, the decoding unit 121 decodes the command in accordance with the select command information IC. Also, the decoding unit 121 decodes the select information IS.

According to the decode result from the above, the selecting unit 122 of the switching unit 12 makes a chip enable signal CEB_I [1] of the access targeted NAND chip 131 valid. Further, the selecting unit 122 transmits a ready state signal of ready/busy signal RDY/BSY [1] as a response signal to the SSD controller 11 according to the selected chip enable signal CEB_I [1].

Also, as indicated as b) and c) in FIG. 4B, the switching unit 12 makes the chip enable signal CEB_O [1] of NAND chip 131 valid and selects NAND chip 131, on the basis of the chip enable signal CEB_I [1] and the decode result. On the other hand, the switching unit 12 makes the chip enable signal CEBO [0], [2]-[n] of the other NAND chips 130, 132-13n invalid and does not select those NAND chips 130, 132-13n.

Then, each NAND chip 130-13n transmits a ready state or a busy state signal of ready/busy signal RDY/BSY_O [0]-[n] to the switching unit 12, on the basis of its operating state.

Note that TC0, which is a time period between the above time t1 and t4, is a time NAND chip 0 is being selected.

Subsequently, the SSD controller 11 serially issues a predetermined write command (Cmd 80), an address (Adr), write data (WriteData), and write-start command (Cmd 10).

At time t5, as soon as the selected NAND chip 131 finishes writing, NAND chip 131 transmits a busy state signal of ready/busy signal RDY/BSY_O [1] to the switching unit 12.

After time t6, the SSD controller 11 and those units mentioned above repeat the above operation.

Note that TC1, which is a time period between the above time t4 and t6, is a time NAND chip 1 is being selected.

### 3. Advantageous Effects

As described above, utilizing the configuration and operation according to the first embodiment, at least two effects (1) and (2) set forth below are obtained.

(1) Without increasing the number of chip enable signals (CE) of SSD controller 11, a greater number of NAND chips 130-13n can be handled, and it is advantageous in increasing capacity.

When intending to configure a large capacity SSD, the number of chip stacks in one package of NAND chips is not sufficient. Therefore, there tends to be no choice but to increase the number of chip enable signals (CE) in an SSD controller and handle a greater number of NAND chips. However, by simply increasing the number of chip enable signals (CE) in an SSD controller in accordance with the foregoing, the number of chip enable signals (CE) and other control signals (for example, ready/busy signals RDY/BSY) become excessive. When the number of chip enable signals and such are increasing, accordingly, the number of signal pads and/or the size of occupation area of an SSD controller enlarges. Furthermore, it will lead to the cost of manufacturing SSD to increase. Therefore, the situation is that increasing the number of chip enable signals (CE) and other control signals is not preferred.

The SSD controller 11 according to the first embodiment at least includes the embedding unit 111 and the issuing unit 112. The embedding unit (generating unit) 111 generates a NAND chip select information IS for selecting NAND chips 130-13n, and embeds the generated select information IS into a remaining bit area (redundant bit area) RA, which is remaining bits (bits 5-7) of the select command (Cmd CC0-n). The issuing unit 112 issues a unique definitional predetermined select command complying with the NAND interface protocol, the select command includes NAND chip select information IS embedded by the embedding unit 111.

Further, the switching unit 12 according to the first embodiment at least includes the decoding unit 121 and the selecting unit 122. The decoding unit 121 decodes the NAND chip select information IS embedded in the select command (Cmd CC0-n) (S12 in FIG. 3). The selecting unit 122 selects one intended, access targeted NAND chip out of NAND chips 130-13n according to the decoding result of NAND chip select information IS from the decoding unit 121 (S14 in FIG. 3).

As a result, the switching unit 12 makes the chip enable signal CEB_O [0] of NAND chip 130 valid and selects NAND chip 130 while making the chip enable signal CEB_O [1]-[n] of the other NAND chips 131-13n invalid and not selecting those NAND chips 131-13n (time period TC0 in FIG. 4A and FIG. 4B).

As described above, in the first embodiment, the switching unit 12 is arranged between the SSD controller 11 and the NAND memory 13. Further, the switching unit 12 groups chip enable signals CEB_I from the SSD controller 11 ([m:0]). As a result, even when the number of chip enable signals CEB_O [0]-[n] of NAND chips 130-13n is increased, the number of chip enable signal CEB_I [m:0] on the SSD controller 11 side can be decreased (m(number of first signals)<n(number of first signals)).

Thus, the SSD 10 according to the first embodiment is advantageous in increasing capacity because it can handle a greater number of NAND chips 130-13n without increasing the number of chip enable signals (CEB_I) on the SSD controller 11 side.

(2) The number of ready/busy signals (RDY/BSY) of the SSD controller 11 can be decreased.

According to the first embodiment, as described above, grouping the chip enable signals (CEB) toward the SSD controller 11 ([m:0]) is possible. Therefore, even when the number of ready/busy signals RDY/BSY [0]-[n] on the NAND memory 13 side increases along with the increase in number of NAND chips 130-13n, the fact that the number of ready/busy signals RDY/BSY [m:0] can be decreased is advantageous.

In addition, as stated in (1) and (2) above, since the number of chip enable signals (CE) and ready/busy signals (RDY/BSY) of the SSD controller 11 can be decreased, the increase in the number of signal pads along with the increase in the number of those signals can be prevented. As a result, the increase in the size of the occupation area of the SSD controller 11 can be prevented, and this embodiment has a merit that the cost of manufacturing SSD 10 can be reduced.

### Second Embodiment

Next, the SSD 10 according to the second embodiment is described. In the following description, no detailed explanation of configurations and operations similar to those of the first embodiment is given.

[Circuit Configuration]

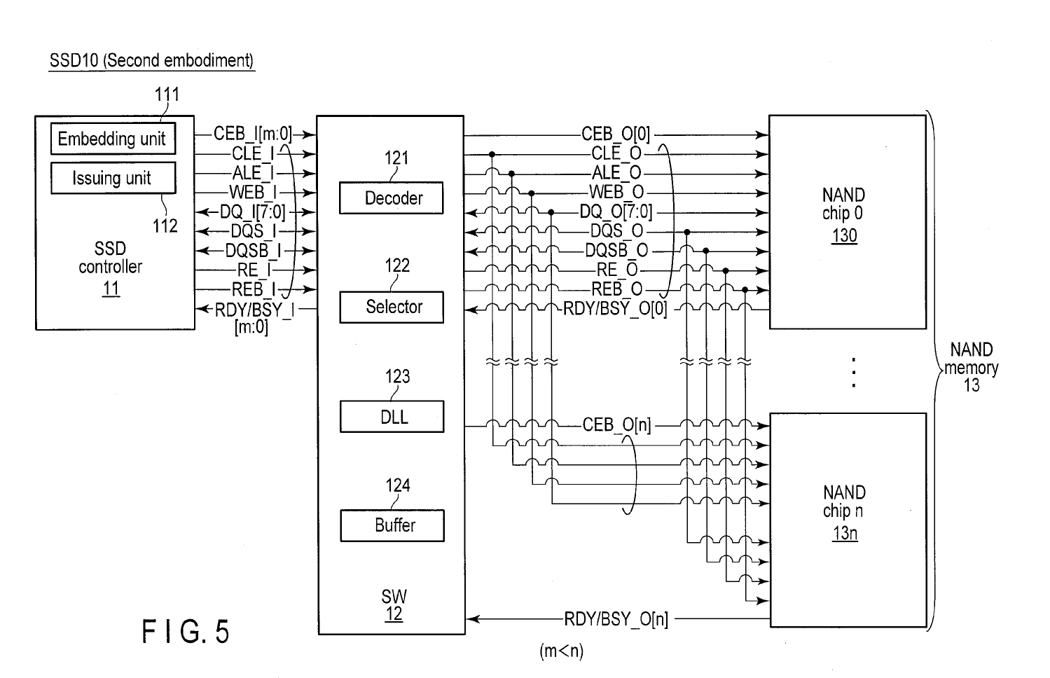

First, referring to FIG. 5, a circuit configuration of the memory system (SSD) 10 according to the second embodiment is described.

As shown, the SSD 10 according to the second embodiment differs from the first embodiment in that the switching unit 12 further includes a delaying unit 123 and a buffer 124.

The buffer (storage unit) 124 temporarily stores a control signal (chip enable signal CEB) received from the SSD controller 11, an address (Adr), data (WriteData), and a command (select command), etc. The above set of the control signal, etc. stored in the buffer 124 is restored and utilized when the switching unit 12 is accessing each NAND chip 130-13n.

The delaying unit (DLL, a signal delay circuit) 123 gives a predetermined delay to the restored control signal, etc. when the switching unit 12 is accessing each NAND chip 130-13n, in order to meet an AC spec prescribed in the NAND interface. Detailed description will hereinafter be given.

[Signals]

Next, referring to FIG. 5, signals exchanged between each circuit above, configuring the SSD 10 for the second embodiment are described.

The second embodiment differs from the first embodiment in that there is not any signal transmitted from the SSD controller 11, directly to the NAND memory 13, without involving the switching unit 12. Therefore, in principle, the all signals, transmitted form the SSD controller 11, are exchanged with the NAND memory 13 through the switching unit 12.

The second embodiment is the same as the first embodiment in that, between the SSD controller 11 and the switching unit 12, chip enable signals CEB_I and ready/busy signals RDY/BSY_I are grouped ([m:0]). In addition, the same as the first embodiment, the number of groups m is less than the number of NAND chips n (m<n). Therefore, the number of chip enable signals CEB_I and ready/busy signals RDY/BSY_I can be decreased even when the number of NAND chips 130-13n is increased.

Since the other configurations are substantially similar to those of the first embodiment, they are not described in detail.

[NAND Chip Select Flow]

Now, NAND chip select flow of the memory system 10 according to the second embodiment in the above-mentioned configuration is described.

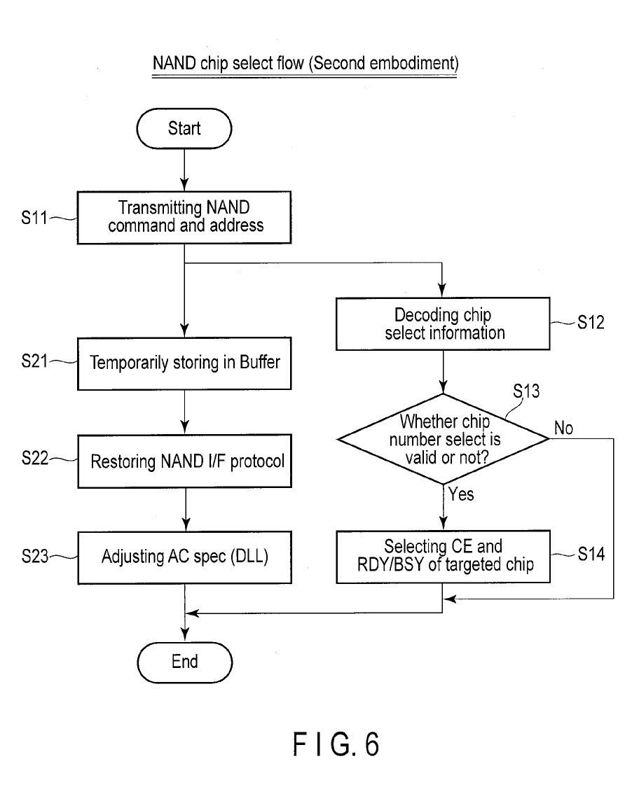

As shown in FIG. 6, the memory system 10 according to the second embodiment selects one of the access targeted NAND chips 130-13n. In this instance, NAND chip 130 is selected and accessed in the write operation.

In steps S11 to S14 of FIG. 6, the SSD 10 undertakes the same operation as the first embodiment.

Further, in step S21, the buffer 124 temporarily stores a control signal (chip enable signal CEB, etc.), an address (Adr), data (WriteData), and a command (select command), received from the SSD controller 11.

In step S22, the control unit (not shown) of the switching unit 12 restores the protocol based on which each NAND chip 130-13n are accessed, utilizing the control signal, etc. stored in the buffer 124.

In step S23, the delaying unit 123 gives a predetermined delay to the restored control signal, etc. when the switching unit 12 is accessing each NAND chip 130-13n, in order to meet an AC spec prescribed in the NAND interface.

The same applies hereafter, the memory system 10 according to the second embodiment repeats the NAND chip select operation.

[NAND Chip Select Timing Chart]

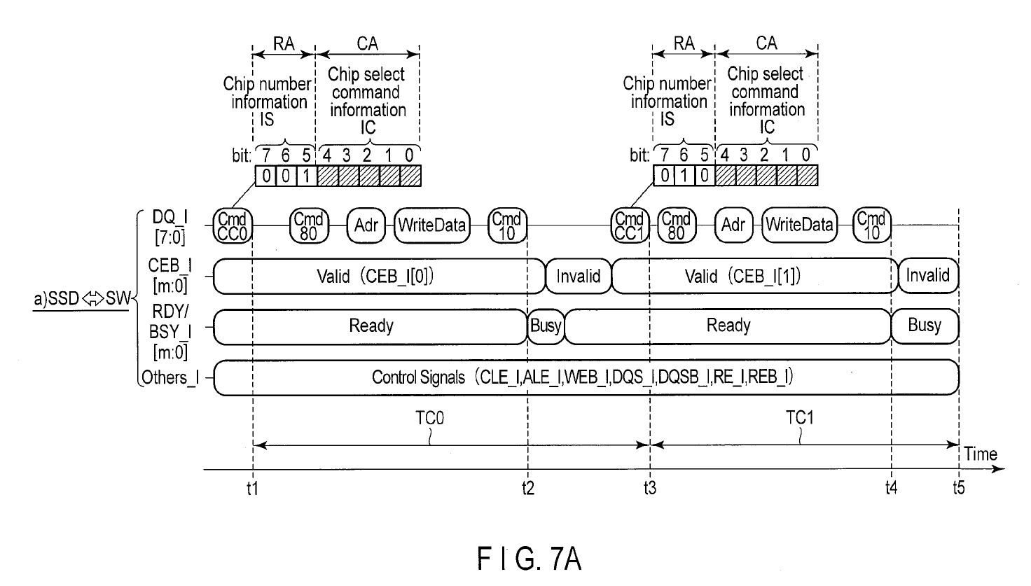

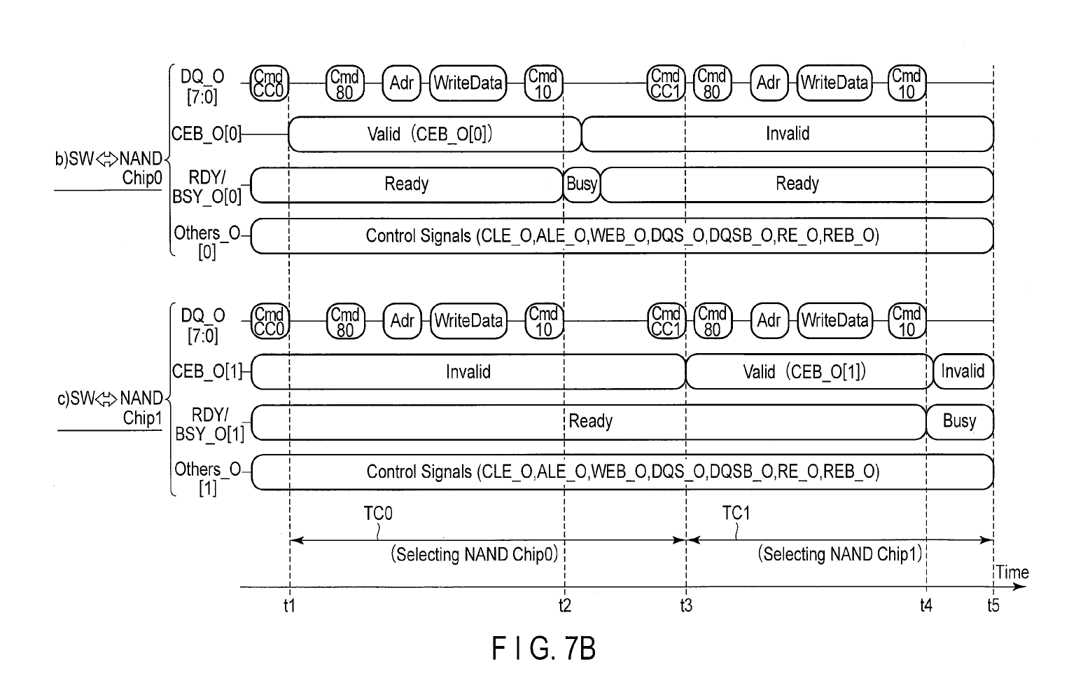

Referring to the NAND chip select flow according to the second embodiment, for example, a timing chart of selecting NAND chip in the write operation is shown in FIG. 7A and FIG. 7B. In this instance, NAND chips 130 and 131 are accessed serially.

First, at time t1, as indicated as a) in FIG. 7A, the decoding unit 121 decodes the select command (Cmd CCO) for selecting NAND chip 130 and the NAND chip select information IS embedded in the command.

Here in the second embodiment, the all signals, transmitted from the SSD controller 11, are transmitted to the switching unit 12. Accordingly, the other control signals (CLE_I, ALE_I, WEB_I, DQS_I, DQSB_I, RE_I, and REB_I) which are transmitted from the SSD controller 11 are also transmitted to the switching unit 12.

Also, as indicated as b) and c) in FIG. 7B, the switching unit 12 makes the chip enable signal CEB_O [0] of NAND chip 130 valid and selects NAND chip 130, on the basis of the chip enable signal CEB_I [0] and the decode result. On the other hand, the switching unit 12 makes the chip enable signal CEB_O [1]-[n] of the other NAND chips 131-13n invalid and does not select those NAND chips 131-13n.

Subsequently, the control unit of the switching unit 12 restores the NAND access utilizing the select command (Cmd CC0), the write command (CMD 80), the address (Adr), the write data (WriteData), and the write-start command (Cmd 10) stored in the buffer 124. In addition, the delaying unit 123 gives a predetermined delay time.

The same applies hereafter; the same operations as described above are repeated.

Since the other operations are substantially similar to those of the first embodiment, they are not described in detail.

[Advantageous Effects]

As described above, utilizing the configuration and operation according to the second embodiment, at least the two effects (1) and (2) listed above are obtained.

In addition, in the SSD 10 according to the second embodiment, the switching unit 12 further includes the delaying unit 123 and the buffer 124.

The buffer 124 temporarily stores a control signal (chip enable signal CEB), an address (Adr), data (WriteData), and a command (select command), which are received from the SSD controller 11 (S21 in FIG. 6).

The control signals, etc. stored in the buffer 124 are restored and utilized when the switching unit 12 is accessing each NAND chip 130-13n (S22 in FIG. 6 and t1 in FIGS. 7A, 7B).

The delaying unit 123 gives a predetermined delay to the restored control signal, etc. when the switching unit 12 is accessing each NAND chip 130-13n, in order to meet an AC spec prescribed in the NAND interface (S23 in FIG. 6).

Thus, the memory system 10 according to the second embodiment is applicable as needed basis.

### Third Embodiment

Next, the SSD 10 according to the third embodiment is described. In the following description, no detailed explanation of configurations and operations similar to those of the second embodiment is given.

[Circuit Configuration]

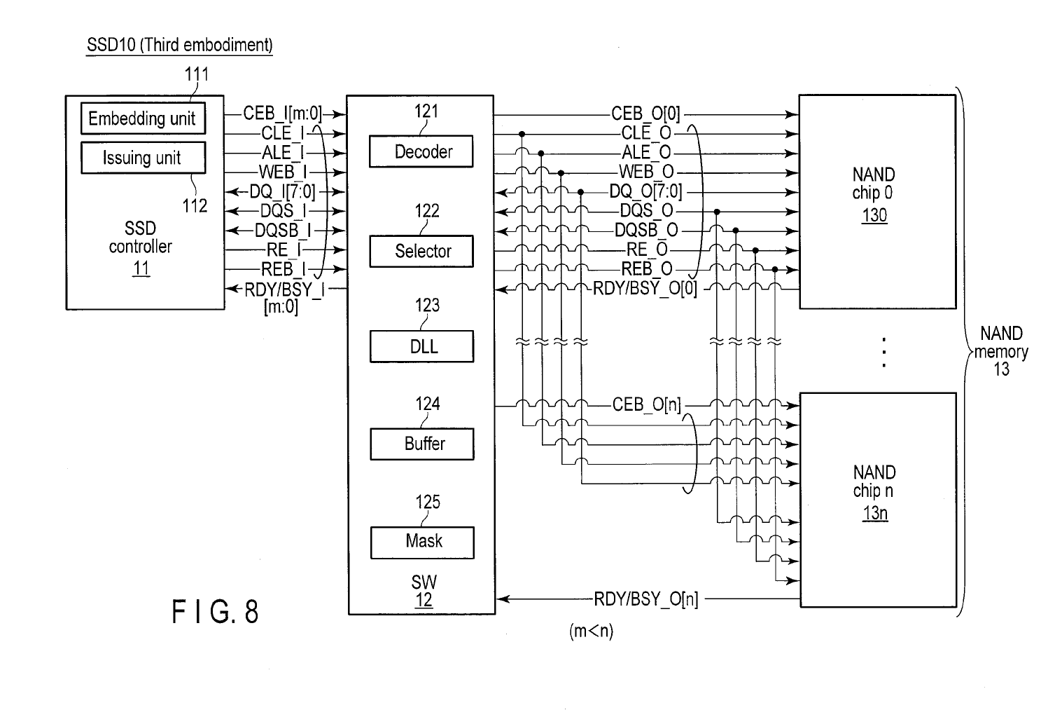

First, referring to FIG. 8, a circuit configuration of the memory system (SSD) 10 according to the third embodiment is described.

As shown, the SSD 10 according to the third embodiment differs from the second embodiment in that the switching unit 12 further includes a masking unit 125.

The masking unit (Mask, erasing unit) 125 erases unnecessary signals out of a select command (Cmd CC), a control signal (chip enable signal CEB, etc.), an address (Adr), data (WriteData), etc. which are stored in the buffer 124, and are not necessary to be provided to NAND chips 130-13n. In this embodiment, the masking unit 125 erases the select commands (Cmd CC0-CCn) out of the signals stored in the buffer 124, which are not necessary for NAND chips 130-13n.

Since the other configurations and signals are substantially similar to those of the second embodiment, they are not described in detail.

[NAND Chip Select Flow]

Next, in the configuration set forth above, NAND chip select operation of the memory system 10 according to the third embodiment is described.

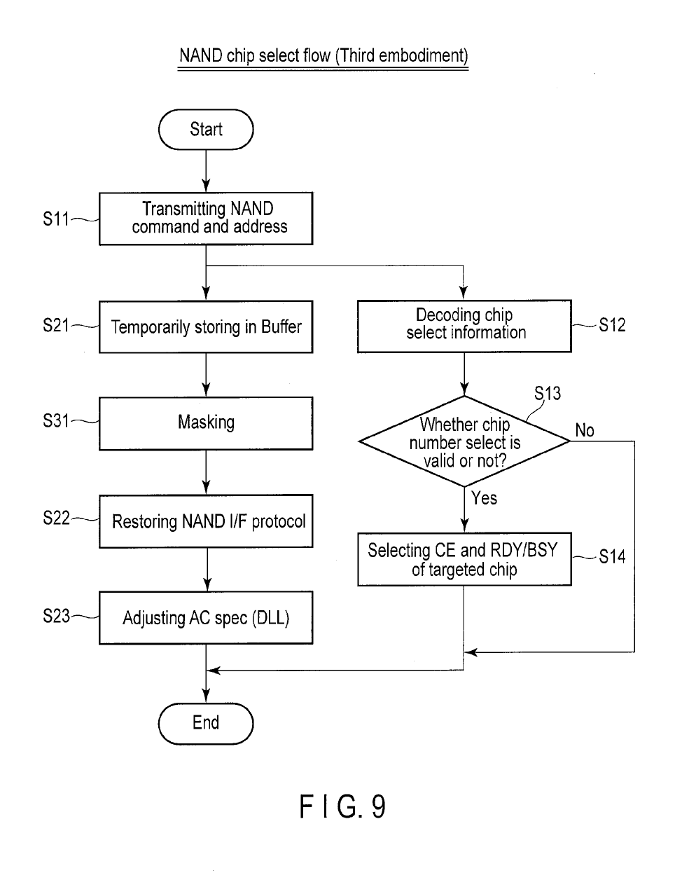

As shown in FIG. 9, the memory system 10 according to the third embodiment selects one of the access targeted NAND chips 130-13n. In this instance, NAND chip 130 is selected and accessed in the write operation.

As shown, the NAND chip select flow according to the third embodiment differs from the one according to the second embodiment in that it further includes step S31.

Specifically, in steps S11 to S21, the SSD 10 starts with the same operation as the second embodiment.

Then, in step S31, the masking unit 125 erases the select commands (Cmd CC0-CCn) of the control signals stored in the buffer 124, which are not necessary to be provided to NAND chips 130-13n. For example, the masking unit 125 erases the select command (Cmd CC0) which is not necessary for NAND chip 130.

In step S22, the control unit (not shown) of the switching unit 12 restores the access to each NAND chip 130-13n, utilizing the control signal, etc. which are not erased by the masking unit 125. To be more precise, the control unit of the switching unit 12 restores the NAND access utilizing the write command (Cmd 80), the address (Adr), the write data (WriteData), and the write-start command (Cmd 10) stored in the buffer 124, excluding the erased select command (Cmd CC0).

The same applies hereafter; the memory system 10 according to the third embodiment repeats the NAND chip select operation.

[NAND Chip Select Timing Chart]

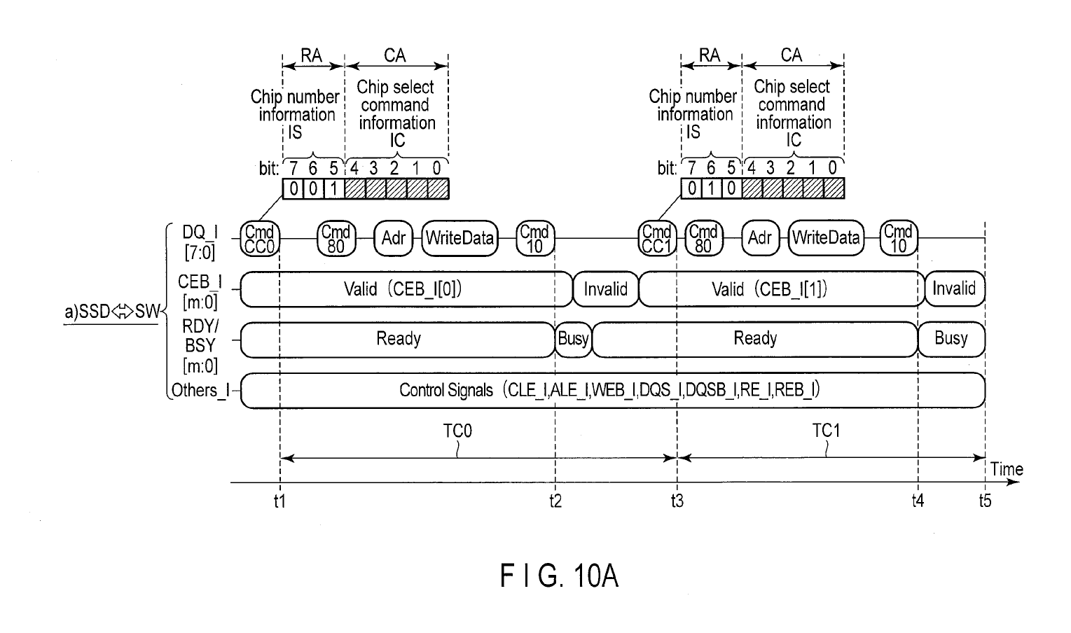

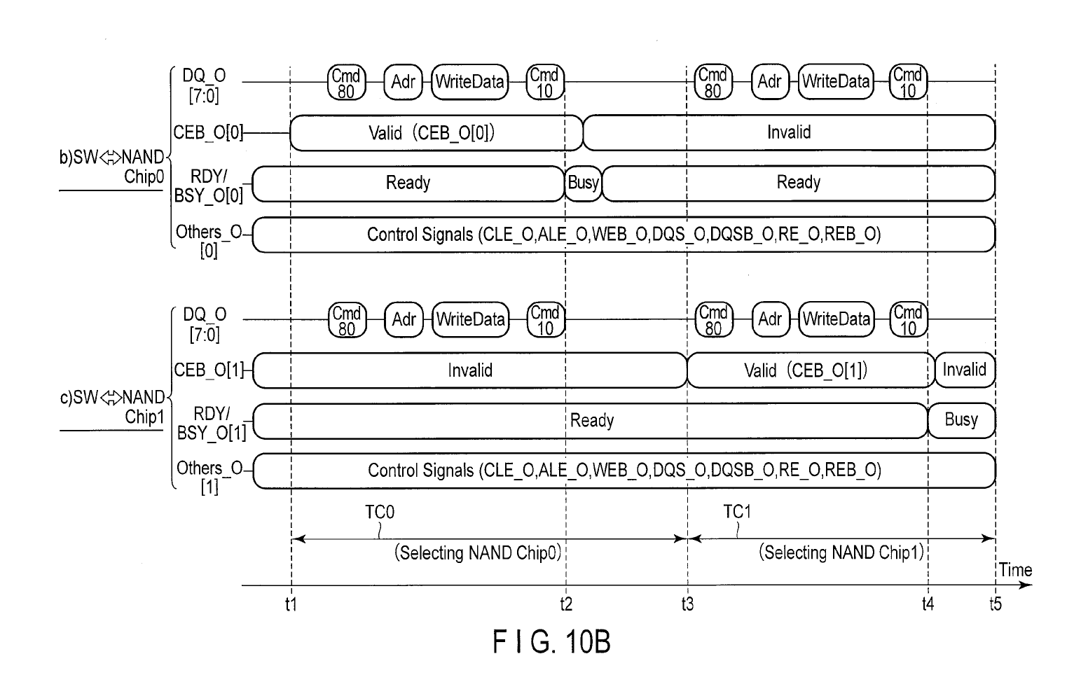

Referring to the NAND chip select flow according to the third embodiment, for example, a timing chart of selecting NAND chip in the write operation is shown in FIG. 10A and FIG. 10B. In this instance, NAND chips 130 and 131 are accessed serially.

First, at time t1, as indicated as a) in FIG. 10A, the decoding unit 121 decodes the select command (Cmd CCO) for selecting NAND chip 130 and the NAND chip select information IS embedded in the command.

Then, as indicated as b) and c) in FIG. 10B, the masking unit 125 according to the third embodiment erases the select commands (Cmd CC0) of the control signals stored in the buffer 124, which are not necessary to be provided to NAND chip 130. Therefore, no select command (Cmd CC0) is given to the NAND memory 13.

Subsequently, the control unit of the switching unit 12 restores the NAND access to NAND chips 130-13n utilizing the write command (Cmd 80), the address (Adr), the write data (WriteData), and the write-start command (Cmd 10) stored in the buffer 124, excluding the erased select command (Cmd CC0).

The same applies hereafter; the same operations as described above are repeated.

Since the other operations are substantially similar to those of the second embodiment, they are not described in detail.

[Advantageous Effects]

As described above, utilizing the configuration and operation according to the third embodiment, at least the two effects (1) and (2) listed above are obtained.

In addition, in the SSD 10 according to the third embodiment, the switching unit 12 further includes the masking unit 125 erasing the select commands (Cmd CC0-CCn) of the control signals stored in the buffer 124, which are not necessary to be provided to NAND chip 130.

Therefore, the control unit of the switching unit 12 restores the NAND access to NAND chips 130-13n utilizing the sequence of the write command (Cmd 80), the address (Adr), the write data (WriteData), and the write-start command (Cmd 10) stored in the buffer 124, excluding the erased select command (Cmd CC0).

Thus, the memory system 10 according to the third embodiment is applicable as needed basis.

(Variation 1 (an Example where Select Information is Embedded in Data))

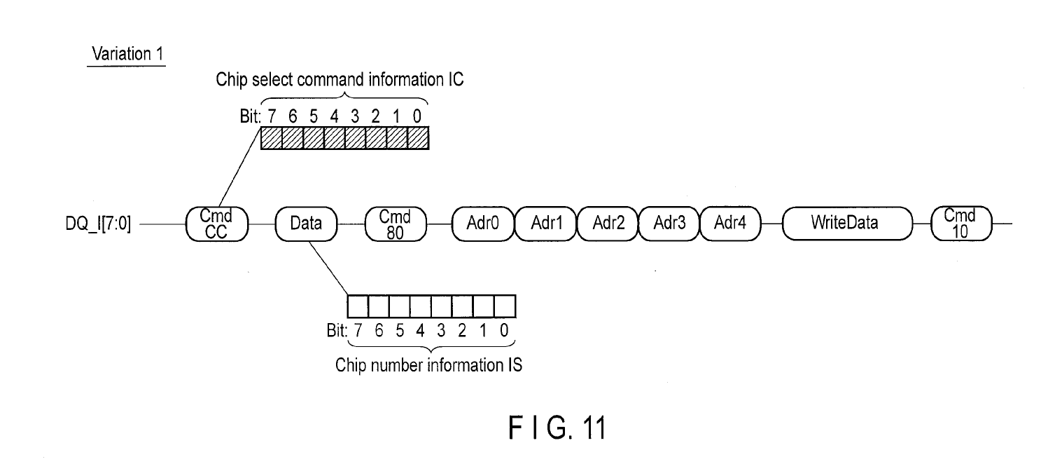

Next, referring to FIG. 11, the SSD 10 according to variation 1 is described. The variation 1 is an example where select information IS is embedded in data. In the following description, no detailed explanation of configurations and operations similar to those of the first to the third embodiments is given.

As shown, in the variation 1 differs from the first to the third embodiments in that the embedding unit 111 embeds chip number information, as NAND chip select information IS of the NAND chip to be selected, into 8-bit data (bits 0-7).

Also, as described above, the chip select command information IC as 8 bits (bits 0-7) chip select command, which the NAND chip does not recognize, is embedded in the select command (Cmd CC).

When such a select command (Cmd CC) as shown is received, the decoding unit 121 decodes the select command (Cmd CC). The decoding unit 121 decodes the select information IS on the basis of data.

On the basis of the decode result, the selecting unit 122 of the switching unit 12 can select one of the access targeted NAND chips 130-13n.

Since the other configurations and operations are substantially similar to those of the first to the third embodiments, they are not described in detail.

As described above, utilizing the variation 1, at least the two effects (1) and (2) listed above are obtained. Thus, the memory system 10 according to the variation 1 is applicable as needed basis.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a plurality of nonvolatile memories;
a controller which includes a generator which generates select information and embeds the generated select information into redundant bit information of a select command, an issuing unit which issues the select command including the select information; and
a switching unit which includes a decoder which decodes the select information and the select command and a selector which selects one of the plurality of nonvolatile memories on the basis of the decoding result from the decoder.

2. The memory system of claim 1, wherein the select command is a definitional command complying with an interface protocol of the plurality of nonvolatile memories.

3. The memory system of claim 1, wherein the switching unit further includes a buffer which stores a first signal received from the controller.

4. The memory system of claim 3, wherein the switching unit restores an access to the plurality of nonvolatile memories utilizing the first signal stored in the buffer.

5. The memory system of claim 4, wherein the switching unit further includes a delaying unit which gives a first delay to the restored first signal.

6. The memory system of claim 3, wherein the switching unit further includes a masking unit which erases signals out of the signals stored in the buffer, which are not necessary for the nonvolatile memories.

7. The memory system of claim 6, wherein the masking unit erases the select command out of the first signals stored in the buffer.

8. The memory system of claim 1, wherein the generator embeds the generated select information into data.

9. The memory system of claim 1, wherein the select signals, exchanged between the controller and the switching unit, which select the plurality of nonvolatile memories are grouped on the basis of the number of first signals,
and the number of first signals is less than the number of second signals of the select signals which are exchanged between the switching unit and the plurality of nonvolatile memories.

10. The memory system of claim 1, wherein ready/busy signals, exchanged between the controller and the switching unit, are grouped on the basis of the number of first signals,
and the number of first signals is less than the number of second signals of the ready/busy signals which are exchanged between the switching unit and the plurality of nonvolatile memories.

11. A storage system that uses the memory system of claim 1.

12. The storage system of claim 11, wherein the select command is a definitional command complying with an interface protocol of the plurality of nonvolatile memories.

13. The storage system of claim 11, wherein the switching unit further includes a buffer which stores a first signal received from the controller.

14. The storage system of claim 13, wherein the switching unit restores an access to the plurality of nonvolatile memories utilizing the first signal stored in the buffer.

15. The storage system of claim 14, wherein the switching unit further includes a delaying unit which gives a first delay to the restored first signal.

16. The storage system of claim 13, wherein the switching unit further includes a masking unit which erases signals out of the signals stored in the buffer, which are not necessary for the nonvolatile memories.

17. The storage system of claim 11, wherein the generator embeds the generated select information into data.

18. The storage system of claim 11, wherein the select signals, exchanged between the controller and the switching unit, which select the plurality of nonvolatile memories are grouped on the basis of the number of first signals,
and the number of first signals is less than the number of second signals of the select signals which are exchanged between the switching unit and the plurality of nonvolatile memories.

19. The storage system of claim 11, wherein ready/busy signals, exchanged between the controller and the switching unit, are grouped on the basis of the number of first signals,
and the number of first signals is less than the number of second signals of the ready/busy signals which are exchanged between the switching unit and the plurality of nonvolatile memories.

20. A memory system comprising:
a plurality of nonvolatile memories;
a generator which generates a select information;
an issuing unit which issues a select command including the select information;
a decoder which decodes the select information and the select command; and
a selector which selects one of the plurality of nonvolatile memories on the basis of the decoding result from the decoder.
